(19) United States
(12) Patent Application Publication
(10) Pub. No.: US 2022/0082131 A1
(43) Pub. Date: Mar. 17, 2022

(54) INSTALLATION DEVICE AND INSTALLATION METHOD

(71) Applicant: AKTIEBOLAGET SKF, GOTEBORG (SE)

(72) Inventor: Alexander Mocnik, Steyr (AT)

(21) Appl. No.: 17/406,422

(22) Filed: Aug. 19, 2021

(30) Foreign Application Priority Data
Sep. 14, 2020 (DE) 102020211520.6

(51) Int. Cl. F16D 1/08; F16D 3/06

(52) U.S. Cl. CPC F16D 1/0876; F16D 2250/0061; F16D 2250/0084; F16D 3/065

(57) ABSTRACT

An installation device for installing rollers in a shaft-hub connection includes a base ring having radially inwardly opening recesses configured to receive axial end portions of the rollers. The recesses extend axially and are distributed circumferentially, and the base ring including the received rollers is configured to be pushed onto a shaft. Also an installation method of installing the installation unit and rollers between a shaft and a hub.

### CROSS-REFERENCE

This application claims priority to German patent application no. 10 2020 211 520.6 filed on Sep. 14, 2020, the contents of which are fully incorporated herein by reference.

### TECHNOLOGICAL FIELD

The present invention relates to an installation device for installing rollers in a shaft-hub connection and to an installation method for installing rollers in a shaft-hub connection.

### BACKGROUND

In shaft-hub connections or the like, rollers can be used as coupling elements for force transmission. In electrically insulated shaft-hub connections, such rollers can also be used in order to provide insulation between the shaft and the hub in addition to performing a coupling between the shaft and the hub. In this case, ceramic rollers can be used, for example.

Irrespective of the application, in order to prevent a loss of the rollers during installation onto a shaft-hub connection, the rollers are usually first attached onto the shaft by hand. For this purpose cable ties, installation sleeves, or the like can be used that must be removed again after installing the rollers, and then installing the hub, onto the shaft. However, manually securing the rollers on the shaft is very time-intensive, especially with large quantities.

### SUMMARY

It is therefore an aspect of the present disclosure to make possible an improved installation of rollers in a shaft-hub connection.

The installation device serves for the installation of rollers in a shaft-hub connection. The shaft-hub connection can in particular be an electrically insulating shaft-hub connection, for example, a connection between a hollow shaft or motor shaft of an electric motor and an input/transmission shaft or hub. Here the rollers serve for force transmission between the shaft and the hub. With an electrically insulated shaft-hub connection, in order to ensure an electrical insulation between the shaft and the hub, in this case the rollers can be configured as electrically insulating rollers, and can be comprised of ceramic, for example.

The installation device includes a base ring that includes radially inwardly open recesses for receiving the rollers. Here the recesses extend axially and are distributed circumferentially, preferably in a uniform manner. The rollers can be introduced in these recesses for installation onto the shaft and are retained in these recesses. The base ring with the received rollers is can then be pushed onto a shaft. During the installation, the rollers are retained in position by the base ring without a further manual retention of the rollers or a fixing of the rollers by cable ties or the like being required as has been the case with previous installation processes.

By using the installation device, it is thus possible to first equip the installation device with the corresponding number of rollers in a simple manner and subsequently push it onto the shaft.

The recesses can in particular have a shape complementary to that of the rollers. Due to this complementary shape, the rollers are enclosed on the outer surfaces by the recesses. In addition, the recesses can be provided with a stop element axially on one side in order to axially support the rollers when they are introduced in the base ring or the recesses. These stop elements thus serve to support the ends of the rollers received in the installation device.

According to a further embodiment, the installation device includes retaining bridges for the stabilizing of the rollers during the installation. The retaining bridges are disposed circumferentially between the recesses. Here the retaining bridges abut in particular against the rollers radially inside the pitch-circle diameter. On the one hand, the rollers can thus be supported in the axial direction by the retaining bridges, in particular when the retaining bridges extend beyond the recesses in the axial direction. On the other hand, in combination with the recesses the retaining bridges can serve to enable the rollers to be clamped into the installation device. This simplifies the installation onto the shaft since the rollers cannot fall out of the installation device during the installation process.

The retaining bridges can include recesses in order to facilitate lubricant flow in the installed state. Here the retaining bridges can in particular include corresponding openings respectively between the rollers or recesses. Due to these openings a through-flow of lubricant inside the shaft-hub connection can be made possible when the installation device, including the rollers, is installed on the shaft and the hub is pushed on. Due to the openings, the installation device can remain on the shaft-hub connection without interfering with the lubricant through-flow, whereby a lubrication between the shaft, the hub, and the rollers can also be ensured in the fully installed state.

According to a further embodiment, a side surface of the base ring forms a stop surface for a stop element of the shaft. When the installation device is pushed onto the shaft, a side surface of the base ring can abut against a stop element of the shaft. The end position between the installation device and the shaft can be defined by the stop surface of the installation device and the stop element of the shaft.

On the side opposite the stop surface the base ring can include a chamfer that is adapted to a shape of the hub of the shaft-hub connection. This means that on the opposite side surface of the base ring that is not facing the stop element of the shaft, the shape of the base ring can be adapted to the shape of the hub in order to ensure an optimal clamping of the installation device between the hub and the shaft in the fully installed state.

According to a further embodiment, a side surface of the base ring includes depressions, opposite the recesses, in order to support rollers of an adjacent installation device. These depressions are in particular disposed on the rear side of the stop element and can support the received rollers of an adjacent installation device in an interference-fit manner. For example, a plurality of installation devices can be stacked in alignment with one another, each including rollers received therein. In order to be able to simplify the transport of rollers, the installation devices can not only be stacked, but can also be pushed onto a support sleeve, such as, for example, a cardboard sleeve, and the rollers can be disposed in alignment with respect to one another.

According to a further embodiment, the base ring includes radially outward radial openings for an engagement by a tool. In order to permit an automated removal of installation devices and an automated installation of the rollers onto a shaft using the installation device, these openings can be provided into which a tool can engage in a simple manner. The tool can then grip an installation device, including rollers received therein, and push it onto a shaft. This is advantageous in particular with large quantities.

According to another embodiment, an installation device for installing rollers in a shaft-hub connection may include a base ring having radially inwardly opening recesses configured to receive axial end portions of the rollers. The recesses extend axially and are distributed circumferentially, and the base ring including the received rollers is configured to be pushed onto a shaft. The recesses each include a curved side wall configured to engage a portion of a curved side wall of the rollers and an axially facing bottom wall configured to support an axial end surface of the rollers. The installation device also includes retaining bridges projecting axially from the base ring and supported only at one end, the bridges being configured to stabilize the rollers during installation, and the retaining bridges extend from the base ring at locations circumferentially between the recesses.

The installation device can also be configured such that during the installation into the shaft-hub connection the device can be pushed downward from the rollers and can remain in the shaft-hub connection after the installation. In this way the installation device can exercise a dual function. On the one hand, it can simplifies the installation of the rollers onto the shaft or into the shaft-hub connection, and on the other hand, after the installation it can serve as a spacer or distance sleeve between the shaft and the hub. In particular when the installation device is simultaneously used as a distance sleeve after the installation, the installation device is preferably formed from a nonconductive or insulating material, for example, formed of plastic. After the installation, an insulation between the hub and the shaft can thus be achieved both by the rollers, in particular when they are manufactured from ceramic, and the installation device itself performing the function of an insulating spacer. Here the rollers insulate in the radial direction, whereas the installation device insulates in the axial direction.

According to a further aspect, a shaft-hub connection is disclosed that includes a shaft and a hub pushed onto the shaft. An installation device as described above is disposed between the shaft and the hub, wherein the installation device in particular acts as an insulating spacer.

According to a further aspect, an installation method is proposed for installing rollers in such a shaft-hub connection. The method includes the following steps: disposing rollers in an installation device as described above, pushing the installation device onto the shaft, and pushing the hub onto the shaft, wherein the hub pushes the installation device from the rollers, and the installation device is clamped between the shaft and the hub.

As is described above, in this case the installation device can exercise a dual function, namely on the one hand as retaining device for installing the rollers in the shaft-hub connection and on the other hand as a spacer, in particular as an insulating spacer, between the shaft and the hub after the installation.

Further advantages and advantageous embodiments are specified in the description, the drawings, and the claims. Here in particular the combinations of features specified in the description and in the drawings are purely exemplary, so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a perspective view from above of an installation device according to an embodiment of the present disclosure.

FIG. 2 is a perspective view of the installation device of FIG. 1 from below.

FIG. 3 is a bottom plan view of the installation device of FIG. 1.

FIG. 4 is a top plan view of the installation device of FIG. 1.

FIG. 5 is a side elevational view of the installation device of FIG. 1.

FIG. 6 is a perspective view from below of a shaft-hub connection including the installation device of FIG. 1.

FIG. 7 is a perspective view from above of the shaft-hub connection of FIG. 6.

FIG. 8 is a side elevational view of the shaft-hub connection of FIG. 6.

FIG. 9 is a sectional view of installation devices stacked for transport.

FIG. 10 is a further sectional view of installation devices stacked for transport.

### DETAILED DESCRIPTION

In the following, identical or functionally equivalent elements are designated by the same reference numbers.

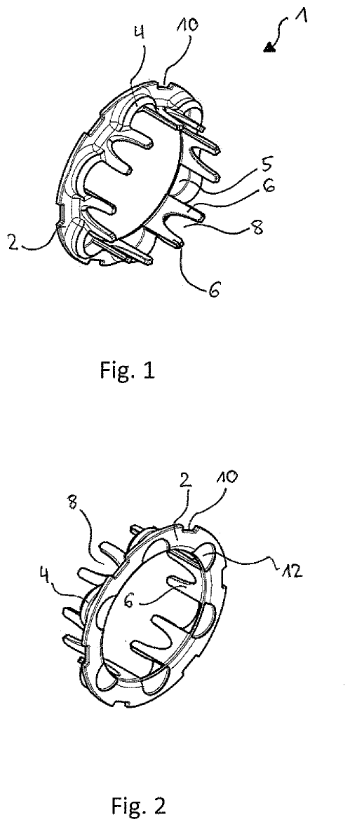

FIG. 1 shows an installation device 1 that serves to retain rollers in a hub-shaft connection during transport and installation, in order to thus simplify the installation into the shaft-hub connection. For this purpose the installation device 1 includes a base ring 2. This base ring 2 includes recesses 4 that are open radially inward in order to receive the rollers. Here the rollers can be retained on their axial end side by stop elements 5 that can be a part of the base ring 2.

In addition, retaining bridges 6 are provided that extend axially. The rollers are supported in their axial extension during transport and installation by the retaining bridges 6 that are respectively disposed on both sides of each recess 4. The retaining bridges 6 each include openings 8 that allow lubricant to flow through the shaft-hub connection after the installation in the shaft-hub connection.

In order to make possible an automated transport and an automated installation, the installation device 1 can include notches 10. A tool can engage in these notches 10 in order to make possible an automated handling of the installation device 1 including the rollers received therein.

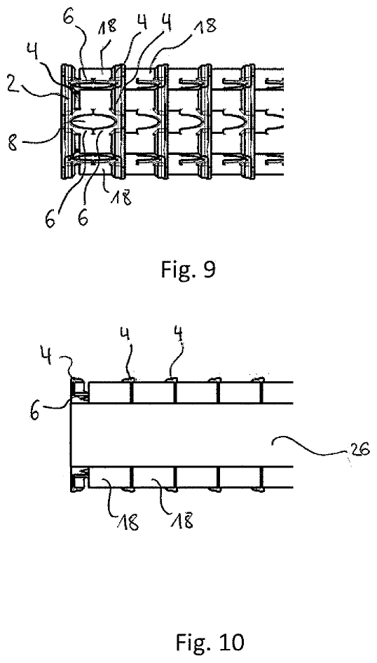

As is shown in FIG. 2, the stop elements 5 can form depressions 12 on their rear side, into which depressions 12 adjacent rollers can engage during transport. This makes possible an aligned stacking of multiple installation devices including the rollers received therein. This is described in more detail in connection with FIGS. 9 and 10.

As is shown in FIGS. 1 and 2, the recesses 4 have a shape complementary to the rollers. Due to this complementary shape, the recesses 4 can enclose the rollers on the outer surfaces of the rollers.

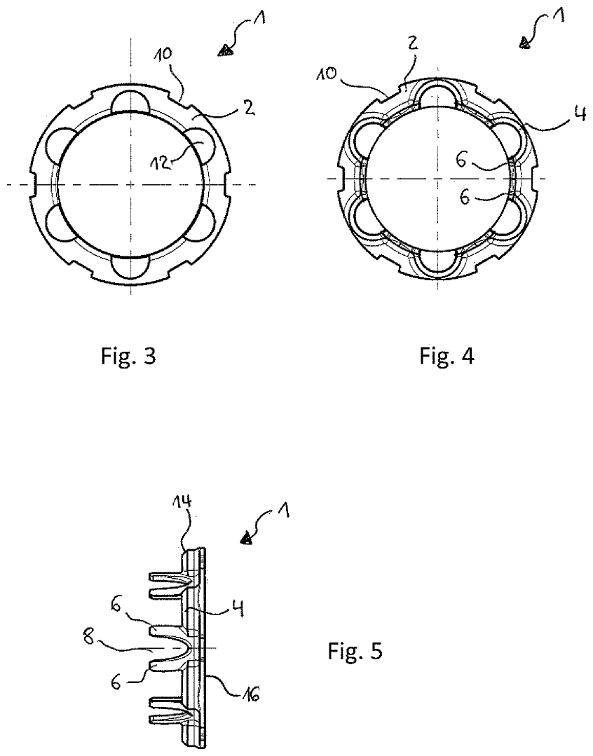

The recesses 4 and retaining bridges 6 can preferably be uniformly distributed circumferentially, as is shown, for example, in FIGS. 3 and 4. Due to this uniform circumferential distribution of the recesses 4 and of the retaining bridges 6, the rollers can also be uniformly distributed circumferentially both during transport and during installation. In this way it can be ensured that the rollers do not abut against one another during transport and installation, which could lead to damage.

If the installation device 1 is installed in a shaft-hub connection, a side surface 16 that is disposed opposite to the retaining bridges 6 and the recesses 4 can serve as a stop surface for a stop element of the shaft-hub connection. In addition, the installation device 1 can include a chamfer 14 on the opposite side, which chamfer can be adapted to a shape of the hub. As will be described below, an optimal seating of the installation device 1 between the shaft and the hub can be ensured by this chamfer 14.

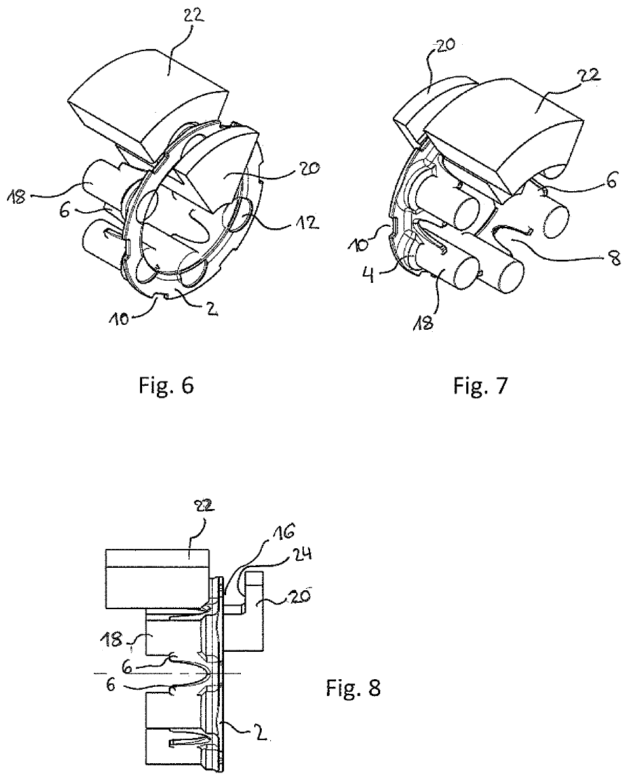

As is shown in FIGS. 6 to 8, the installation device 1 including the rollers 18 received therein can first be pushed onto a shaft 20, for example, a hollow shaft of an electric motor. A hub 22, for example, an input shaft of the electric motor, is subsequently pushed onto the installation device 1, or onto the shaft 20. Due to this process, the hub 22 pushes the installation device 1 toward the stop element 24 of the shaft 20. During this, the installation device 1 is pushed down from the rolling elements 18, which are then disposed, without installation device 1, between the shaft 20 and the hub 22. The installation device 1 is clamped between the shaft 20 and the hub 22, wherein the side surface 16 of the installation device 1 abuts against the shaft 20 on the stop element 24. After the installation, the installation device 1 can serve as a spacer between the shaft 20 and the hub 22. When the installation device 1 is manufactured from plastic or another insulating material, an insulation can additionally occur in the axial direction between the shaft 20 and the hub 22.

In the final position, the installation device 1 is completely pushed down from the rollers 18. Since the installation device 1 remains in the shaft-hub connection and is not removed again, it must be ensured that the installation device 1 does not negatively impact the function of the shaft-hub connection, and, for example, prevent a flow of lubricant. As is described above, the installation device 1 therefore includes openings 8. These serve to make possible a through-flow of lubricant also in the final installation position.

As is already mentioned above, a plurality of installation devices 1 can be stacked in order to make possible a simple transport. This is depicted in FIGS. 9 and 10. For example, the installation devices 1 can be pushed onto a sleeve 26, for example, a cardboard sleeve. Here the rollers 18 of an installation device 1 can engage into the depressions 12 of the adjacent installation device 1 in order to allow an aligned stacking between the installation devices 1. This serves for a secure transport, wherein damage to the rollers 18 can be prevented, since rollers 18 of adjacent installation devices 1 cannot abut against one another.

If the installation devices 1 include notches 10 as are described above, an automated removal of the installation devices 1 from the sleeve 26 can be effected by a tool. An automated placement of the installation devices 1 and installing of rollers 18 in a shaft-hub connection is thereby possible.

Due to the above-described installation device it is thus possible to securely transport and install rollers in a shaft-hub connection. At the same time the installation of the rollers in the shaft-hub connection is simplified, since the installation device can remain in shaft-hub connection after the installation and can act here as a spacer as required.

### REFERENCE NUMBER LIST

1 Installation device
2 Base ring
3 Recesses
4 Stop element
5 Retaining bridges
8 Openings
10 Notches
12 Depressions
14 Chamfer
16 Side surface
18 Rollers
20 Shaft
22 Hub
24 Stop element
26 Sleeve

What is claimed is:

1. An installation device for installing rollers in a shaft-hub connection, comprising:
a base ring having radially inwardly opening recesses configured to receive axial end portions of the rollers,
wherein the recesses extend axially and are distributed circumferentially, and
wherein the base ring including the received rollers is configured to be pushed onto a shaft.

2. The installation device according to claim 1,
wherein the recesses each include a curved side wall configured to engage a portion of a curved side wall of the rollers and an axially facing bottom wall configured to support an axial end surface of the rollers

3. The installation device according to claim 2,
wherein the installation device includes retaining bridges projecting axially from the base ring, the bridges being configured to stabilize the rollers during installation, and
wherein the retaining bridges extend from the base ring at locations circumferentially between the recesses.

4. The installation device according to claim 3, wherein the retaining bridges are spaced to allow lubricant to flow between the bridges in an installed state.

5. The installation device according to claim 3,
wherein the bridges are supported only at one end.

6. The installation device according to claim 3,
wherein the installation device is formed from an electrically insulative material.

7. The installation device according to claim 3, including radially outer radial notches in the base ring configured to be engaged by an installation tool.

8. An assembly comprising:
at least one of the installation device according to claim 3;
the rollers mounted in the installation device with first axial end portions of the rollers received in the recesses and the bridges in contact with curved side surfaces of the rollers; and
a shaft extending through the base ring.

9. The assembly according to claim 8,
wherein the shaft includes a flange in contact with a first axial surface of the base ring.

10. The assembly according to claim 9,
further including a hub,
wherein the shaft and the rollers extend into the hub, and
wherein a second axial surface of the base ring includes a chamfer in contact with the hub.

11. The assembly according to claim 8,
wherein the at least one installation device comprise a plurality of installation devices,
wherein a side surface of the base ring includes depressions opposite the recesses, and
wherein second axial end portions of the rollers of a first one of the installation devices are received in the depressions of a second one of the installation devices.

12. A method of installing rollers in a shaft-hub connection comprising:
providing an installation device according to claim 1,
disposing axial end portions of the rollers in the recesses,
pushing the installation device and rollers onto a shaft, and
pushing the shaft into a hub such that the hub engages the base ring and axially separates the base ring from the rollers.

13. The method according to claim 12,
including clamping the base ring between the hub and a flange of the shaft.
